(19) United States
(12) Patent Application Publication
(10) Pub. No.: US 2003/0090456 A1
(43) Pub. Date: May 15, 2003

(54) Method of mapping linguistic symbols to a sequence of keystrokes and assist memorization with musical notes

(76) Inventor: Kaiwen Lin, Everett, MA (US)

Correspondence Address: KAIWEN LIN, 816 59TH ST., BROOKLYN, NY, 11220, US

(21) Appl. No.: 09/682,970

(22) Filed: Nov. 4, 2001

(51) Int. Cl. G09G 5/00

(52) U.S. Cl. 345/156

(57) ABSTRACT

An input device has four control points corresponding to four fingers of a human hand. The first three control points provide means to traverse a ternary tree. Each node of the ternary tree contains a set of 27 related characters. The fourth control point provides means to enter the chosen node, and the input device uses the corresponding character set. The character set is divided into three subgroups, and the user can use one of the first three control points to choose one group. The divide-and-choose process continues until the desired character is unambiguously chosen. Then the process starts again from the complete 27 characters. The fourth control point provides means to switch among character sets and escape into the ternary tree navigation mode. Furthermore, each control point is associated with a musical note. Because each character has a unique keystroke sequence, each character also has a unique sequence of musical notes, which reinforces the association between character and keystroke sequence to help learning the system.

### BACKGROUND OF INVENTION

The present invention relates generally to human inputting information into computing devices. As the size of the computing devices shrinks, human physical size and characteristics remain the same. Traditional keyboard input methods are inefficient as it was not designed with human physical limitation in mind. Several other methods have been developed to facilitate inputting into computer systems:

1. Mini QWERTY keyboard is a standard QWERTY keyboard shrunk in size in order to fit on a portable device.

2. Telephone keypad has been expanded to input alphabets by assigning several letters to each key.

3. Voice recognition enables users to dictate to the computing devices.

4. Handwriting recognition enables users to write directly and let the computer recognize the written letters. It generally requires the user to use simplified symbols to substitute regular alphabets.

5. Thumbscript uses paths defined with 3 by 3 dots. Each path represents an alphabet.

6. Jog dial provides several options that can be cycled through by turning a wheel with one thumb, then the user can pick the option by pressing on the wheel.

Other patent applications in this field, such as Pat. No. 5,128,672, contains more information about prior arts. However, an ideal and practical method for human interaction with machine remains elusive because many requirements need to be met in order to make the method viable:

1. The device should be small and portable.

2. It should be simple and inexpensive to manufacture and adopt.

3. It should be easy to learn and easy to remember for most common uses.

4. It should be natural and repeatable for large amount of input and long period of use without imposing physical strain on the user.

5. Its rate of input should be fast enough for most use.

6. It should be accurate and predictable. Users should be able to know exactly how to produce the results they want, preferably without even looking at or paying attention to the instrument.

7. It should be flexible and extensible. It should be able to represent symbols from future requirements and different context requirements. Example one, it should be able to be extended to cover specialized symbols in a specific industry, e.g. chemical industry. Example two, it should be able to represent not so often used symbols easily, e.g. “@”, whose importance could not have been foreseen before the widespread use of e-mail.

8. Its use should not interfere with the surrounding. One the one hand, its operation should affect the surrounding environment and person as little as possible. On the other hand, its operation should be independent of the surrounding situation.

### SUMMARY OF INVENTION

The present invention consists of two parts. First, it specifies rules to represent symbols (linguistic and others) with sequences of keystrokes on a set of four keys. These rules together are called the mapping method. Second, it specifies the use of pleasant sound patterns, such as musical notes or harmonies, to help user enforce the association between symbols and key sequences. The use of sound to assist learning the mapping method is called auditory reinforcement.

The mapping method describes four keys designed to match four fingers. The first three keys, corresponding to the index, middle, and ring fingers, choose one symbol from a set using a sequence of strokes that subdivides the set recursively until one and only one option is left. Any of twenty seven letters (twenty six Roman alphabets plus the space character) can be narrowed down with a sequence of three strokes. First, subdivide them into three groups of nine letters, and one keystroke can choose one group. That group is subdivided further into three groups of three letters, and second keystroke chooses one group. The third keystroke pick the correct letter from the final three letters.

The fourth key, controlled by either the thumb or the little finger, provides the functionality to switch to other sets of symbols.

The auditory reinforcement links each keystroke to a musical note. As each character has its own sequence of keystrokes, it also has its own sequence of musical notes. The repetitive echoing of the sequence mentally enforces the keystroke sequence and its association with the character.

### DETAILED DESCRIPTION

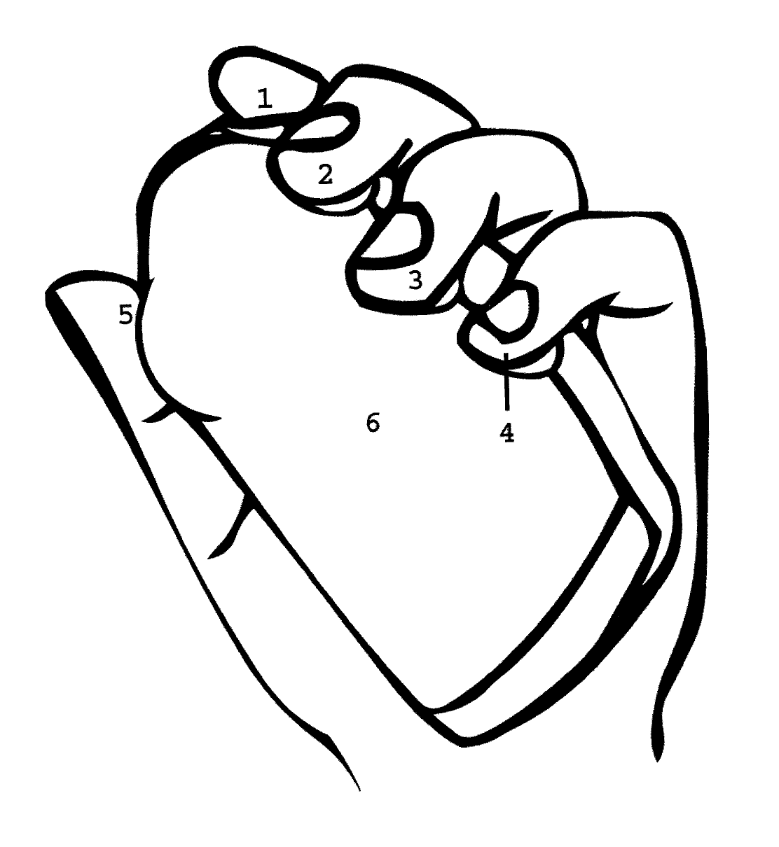

FIG. 1 is a representation of a preferred embodiment of the present invention, which discloses a four-key keyboard able to input various characters, including those found on a standard QWERTY keyboard. The present invention also specifies the use of auditory reinforcement to help users build association between key sequences and characters. In FIG. 1, the operating hand is marked with numbers for its five fingers. Number six marks the area where a handheld device can display information.

The present invention operates by dividing a set of 27 related characters by three recursively until the desired character is narrowed down. The sets are related together in a ternary tree, in which every branch represents one set of characters, and every branch is divided into three sub-branches. The present invention specifies three sets of commonly used characters. A standard governing organization can specify other sets of characters to extend its coverage for specialized characters and other languages” symbols.

The first set of characters include the 26 basic Latin characters and blank space.

The alphabets are arranged alphabetically, followed by the blank space represented as underscore, as shown in Table “Basic Latin Characters”:

[t1]

Basic Latin Characters

| | | |
|---|---|---|
| A B C | D E F | G H I |
| J K L | M N O | P Q R |
| S T U | V W X | Y Z _{—} |

At the starting point, the 27 characters are divided into three groups, represented by the first characters in the group (AJS). To input a letter, the user uses finger one, two, or three to choose one group, which is divided into three subgroups when it is chosen. Then the user chooses among the three subgroups, each has three characters. Finally, the user chooses the desired character. Every time the user finishes choosing a character, the system is returned to the starting point of the character set, also called the initial state. For example, to input letter ‘F’, the user uses the first finger to activate the first button and choose the ‘A’ group. The ‘A’ group is subdivided into the ‘A’, ‘D’, and ‘G’ subgroups. The user continues by activating the second button with the second finger. The second button chooses the ‘D’ group, which has three letters, and the user can finish the process and return to the initial state by choosing ‘F’ with the third finger. To input a blank space, the user chooses the ‘S’ group with the third finger at the beginning, chooses the ‘Y’ subgroup with the third finger, and chooses blank space with the third finger again.

Each button is associated with a musical note. Because every character has a unique sequence of keys, it also has a unique sequence of musical notes, which acts as the auditory reinforcement to help user build association between character and sequence. However, the auditory reinforcement is not required and the input device can work with the sound disabled. In a preferred embodiment, finger one is linked to the musical note DO, finger two to ME, and finger three to SO. Table “Numerical Sequences and Musical Notes Comparison” lists the 27 characters, their numeric sequences, and their musical note sequences:

[t3]

Numerical Sequences and Musical Notes Comparison

| LETTER | NUMERIC SEQUENCE | MUSICAL NOTES |
|---|---|---|
| A | 1, 1, 1 | DO, DO, DO |
| B | 1, 1, 2 | DO, DO, ME |
| C | 1, 1, 3 | DO, DO, SO |
| D | 1, 2, 1 | DO, ME, DO |
| E | 1, 2, 2 | DO, ME, ME |
| F | 1, 2, 3 | DO, ME, SO |
| G | 1, 3, 1 | DO, SO, DO |
| H | 1, 3, 2 | DO, SO, ME |
| I | 1, 3, 3 | DO, SO, SO |
| J | 2, 1, 1 | ME, DO, DO |
| K | 2, 1, 2 | ME, DO, ME |
| L | 2, 1, 3 | ME, DO, SO |
| M | 2, 2, 1 | ME, ME, DO |
| N | 2, 2, 2 | ME, ME, ME |
| O | 2, 2, 3 | ME, ME, SO |
| P | 2, 3, 1 | ME, SO, DO |
| Q | 2, 3, 2 | ME, SO, ME |
| R | 2, 3, 3 | ME, SO, SO |
| S | 3, 1, 1 | SO, DO, DO |
| T | 3, 1, 2 | SO, DO, ME |
| U | 3, 1, 3 | SO, DO, SO |
| V | 3, 2, 1 | SO, ME, DO |
| W | 3, 2, 2 | SO, ME, ME |
| X | 3, 2, 3 | SO, ME, SO |
| Y | 3, 3, 1 | SO, SO, DO |
| Z | 3, 3, 2 | SO, SO, ME |
| space | 3, 3, 3 | SO, SO, SO |

The operations of the second and third sets of characters are similar to the basic Latin character set. The second set of characters contains numbers and numeric operators, shown in Table “Numbers”:

[t4]

Numbers

| | | |
|---|---|---|
| 1 + − | 2 * / | 3 . , |
| 4 < > | 5 0 = | 6 % \hat{ } |
| 7 ( ) | 8 [ ] | 9 { } |

The third set of characters contains special characters and navigational commands commonly used in document editing, shown in Table “Special Characters”:

[t5]

Special Characters

| | | |
|---|---|---|
| . ? ! | , ; : | ″ ′ underline |
| / \ \| | @ previous ˜ | & # $ |
| enter up down | delete pageup pagedown | tab \grave{ } next |

At the starting point of the character set, finger four corresponds to erasing the previous character, if there is one. In the preferred embodiment, finger four is linked to the musical note one octave higher than DO, represented as DO+ hereafter.

When the input device is using the numeric character set or the special character set, user can switch to the alphabetical character set by pressing the sequence (1, 4) at the character set starting point, corresponding to musical notes (DO, DO+) in the preferred embodiment. When the input device is using the alphabetical character set or the special character set, user can switch to the numeric character set with the sequence (2, 4), corresponding to musical notes (ME, DO+). When the input device is using the alphabetical character set or the numeric character set, user can switch to the special character set by pressing the sequence (3, 4), corresponding to musical notes (SO, DO+). Thus, the alphabetical character set is character set number one, the numeric character set is character set number two, and the special character set is character set number three. User can switch among character sets by using the key sequence (x, 4), where x represents one of the three character set numbers.

When the input device is using the alphabetical character set, user can toggle upper and lower case using sequence (1, 4). When the input device is using the numeric character set, user can toggle between the numeric character set and the Unicode character set using sequence (2, 4). Table “Unicode” lists the Unicode character set:

[t6],

Unicode

| | | |
|---|---|---|
| 1 + − | 2 * / | 3 . , |
| 4 < > | 5 0 = | 6 % OK |
| 7 A B | 8 C D | 9 E F |

To enter a Unicode character, the user enters each number using hexadecimal format and finishes by entering ‘OK’, which is the last character of the second row in Table “Unicode”. For example, the character ‘K’ has Unicode 004B. To enter it in Unicode mode, we use the sequence: (2, 2, 2) (2, 2, 2) (2, 1, 1) (3, 1, 3) (2, 3, 3).

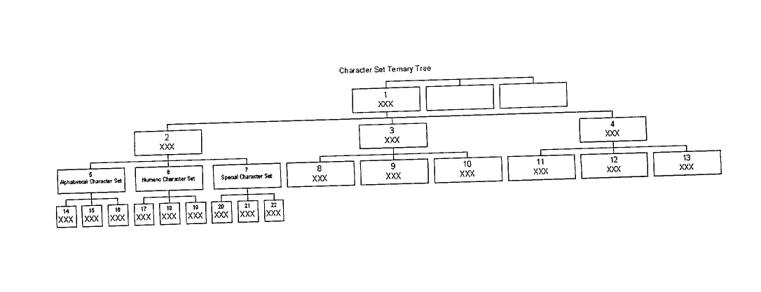

At the starting point of each character set, user can switch to the ternary tree mode with the sequence (1, 1, 4), corresponding to musical notes (DO, DO, DO+) in the preferred embodiment. In the ternary tree mode, user can navigate the ternary tree and choose a character set other than those have been described so far. FIG. 2 depicts a portion of the ternary tree.

Every node of the tree contains a character set and has three sub-branches, which are called child nodes. Each node has two sibling nodes. Every node also has one parent node. For example, in FIG. 2, node 2 is the parent node of node 5, 6, 7. Node 5, the alphabetical character set, has sibling nodes 6 and 7. It also has child nodes 14, 15, and 16. We have discussed the (x, 4) sequences which enables a user to switch among sibling nodes when the input device is using a particular character set.

After the user switches the input device to ternary tree mode using sequence (1, 1, 4), the input device uses a special navigational character set, shown in Table “Ternary Tree Navigation”:

[t7]

Ternary Tree Navigation

| | | |
|---|---|---|
| 1st-child | 2nd-child | 3rd-child |
| parent-node | empty | empty |
| empty | empty | empty |

For example, referring to FIG. 2, if the user escapes into ternary tree mode from node 6 (numeric character set) using the sequence (1, 1, 4), the cursor is positioned at node 6. To navigate to its third child node (node 19), the user can use the sequence (1, 3). To navigate to its grandparent (node 1), use the sequence (2, 1) first to go to its parent node (node 2), then repeat (2, 1) to go to node 1. To navigate to node 20, use sequence (2, 1) to go to node 2, followed by (1, 3) and (1, 1). To navigate to node 10, use sequence (2, 1) twice, followed by (1, 2) and (1, 3). When a node is located, press finger number 4 to use the desired character set.

Besides the character sets described above, the current invention does not specify character sets for other nodes. Different applications will define their own character sets for other nodes. For example, a word processing application might specify copying and pasting operation for node 2, Latin-1 Supplement characters for node 14, Latin Extended-A characters for node 15, and Latin Extended-B characters for node 16, whereas a browser program or graphics program might define differently, such as simulation of mouse cursor. In mouse cursor simulation, the screen is first divided into 3 vertical sections. The user chooses one of the 3 vertical sections, which is divided into 3 horizontal sections. The user chooses one of the 3 horizontal sections, which is divided into 3 vertical sections again. This process alternates until the user narrows down to the desired screen location. With its extensibility, the input system can be used on intelligent watches, personal data assistant (PDA), cell phone, and other portable computing devices. It can be the control panel of machineries, providing a similar user interface across different types of platforms and systems. It can be a universal remote control for home appliances. It can be an interface to a car on the steering wheel.

The variables of the system can be modified to suit different scenarios. First, either left hand or right hand can use the input device. Second, the thumb (number 5 in FIG. 1) can substitute the little finger (number 4 in FIG. 1) or control a jog dial. For situations where the use of four fingers from one hand is inappropriate, the input device can provide other options, such as using two fingers of each hand, using two elbows and wrists, or using two little toes and big toes. In those cases, it is more appropriate to refer to the four buttons or keys as four control points.

The present invention specifies the use of four control points based on several considerations, including the number of characters in basic Latin character set, the aptitudes of the four fingers, the optimum sequence length, and human memory capability. Adhering to the four control points configuration is preferred for all implementations to create a familiar and coherent user experience. However, special situations may require the use of three, five, or other numbers of control points. In a three-control-point configuration that minimizes the number of fingers required (or the number of moving limbs required), binary tree might replace ternary tree to group smaller character sets. On the other hand, a five-control-point configuration can increase the number of characters in a character set to 64 or decrease the stroke sequence length to two for fourteen-character character sets. A mix of different 3, 4, 5, and other numbers of control point configurations can be used. The overriding principle in using one configuration over others is to group most relevant characters together.

The auditory reinforcement mechanism can be extended. Other combinations of sounds can be adopted, and other senses can be stimulated to reinforce the association between characters and keystroke sequences. A similar process to mapping sound to physical movement is playing a musical instrument, such as violin, where each finger is mapped to a note. From the repetitive stimulation of the association between fingers' muscle movement and sound, a musician can remember how to play a piece of music for a long time, even for very fast and sophisticated passages. Another example is telephone dial tone. A user can recognize the dial tone sequence for some frequently used phone numbers. Character tables and dynamic display reminder can be used with the sound to help first time users.

Here are a few input examples. All examples start from when the system is in the lowercase letter mode. Referring to table Numerical Sequences and Musical Notes Comparison, the input sequence for “earth” is (e=1, 2, 2), (a=1, 1, 1), (r=2, 3, 3), (t=3, 1, 2), (h=1, 3, 2). The user will hear (DO, ME, ME), (DO, DO, DO), (ME, SO, SO), (SO, DO, ME), (DO, SO, ME).

Example “Kaiwen Lin”: (shift to uppercase letters=1, 4), (K=2, 1, 2), (shift to lowercase letters=1, 4), (a=1, 1, 1), (i=1, 3, 3), (w=3, 2, 2), (e=1, 2, 2), (n=2, 2, 2), (space=3, 3, 3), (shift to upper case letters=1, 4), (L=2, 1, 3), (shift to lower case letters=1, 4), (l=1, 3, 3), (n=2, 2, 2). Sound sequence: (DO, DO), (ME, DO, ME), (DO, DO+), (DO, DO, DO), (DO, SO, SO), (SO, ME, ME),(DO, ME, ME), (ME, ME, ME), (SO, SO, SO), (DO, DO+), (ME, DO, SO), (DO, DO+), (DO, SO, SO), (ME, ME, ME)

Example changing “hello” to “http://123000@a.com”: (backspace=4), (backspace=4), (backspace=4), (backspace=4), (backspace=4), (h=1, 3, 2), (t=3, 1, 2), (t=3, 1, 2), (p=2, 3, 1), (shift to special characters=3, 4), (:=1, 2, 3), (/=2, 1, 1), (/=2 1, 1), (shift to numbers: 2, 4), (1=1, 1, 1), (2=1, 2, 1), (3=1, 3, 1), (0=2, 2, 2), (0=2, 2, 2), (0=2, 2, 2), (shift to special characters=3, 4), (@=2, 2, 1), (shift to lowercase letters=1, 4), (a=1, 1, 1), (shift to special characters=3, 4), (.=1, 1, 1), (shift to lowercase letters=1, 4), (c=1, 1, 3), (o=2, 2, 3), (m=2, 2, 1).

1. An input device comprising sets of 27 related characters and four control points. The input device works with a selected set of characters at each given point. The set of characters is divided into three subgroups. The subgroup containing the desired input character is divided recursively until the desired input character is unambiguously chosen. The first three control points provide the means to choose the subgroup, and the fourth control point provides the means to switch among different character sets.

2. An input device as recited in claim 1, wherein said control points can be keys on a keyboard, or buttons, or hotspots on a touch screen, or any machine interface capable of letting user indicate at least one changed state to the machine.

3. An input device as recited in claim 1, wherein each control point also activates an assigned signal that provides feedback to the user consistently for the purpose of reinforcing the control point sequence for each character.

4. An input device as recited in claim 3, wherein the assigned signals are auditory musical notes. This includes but not limited to any major third chord, minor third chord, major seventh chord, minor seventh chord, or combinations of chords.

5. An input device as recited in claim 1, wherein one character set is 26 basic Latin characters arranged alphabetically plus blank space character.

6. An input device as recited in claim 1, wherein the fourth control point represents delete.

7. An input device as recited in claim 1, wherein character sets are organized hierarchically in a tree structure. Each node of the tree contains a character set and has a number of child nodes, each of which contains its own character set and has its own child nodes.

8. An input device as recited in claim 7, wherein the number of child nodes is three.

9. An input device as recited in claim 8, wherein sequences for the four control points are defined for switching from one character set to another.
